(19) United States
(12) Patent Application Publication
(10) Pub. No.: US 2024/0322210 A1
(43) Pub. Date: Sep. 26, 2024

(54) FRAMED MEMBRANE ELECTRODE ASSEMBLY

(71) Applicant: HONDA MOTOR CO., LTD., Tokyo (JP)

(72) Inventors: Takaaki SHIKANO, WAKO-SHI (JP); Yukihito TANAKA, WAKO-SHI (JP)

(21) Appl. No.: 18/583,417

(22) Filed: Feb. 21, 2024

(30) Foreign Application Priority Data
Mar. 22, 2023 (CN) 202310286602.7

(51) Int. Cl. H01M 8/1004

(52) U.S. Cl. CPC H01M 8/1004

(57) ABSTRACT

A framed membrane electrode assembly includes a membrane electrode assembly and a resin frame sheet member. The first electrode and the second electrode of the membrane electrode assembly extend outwardly of the entire outer peripheral end of the electrolyte membrane toward the frame sheet member. The outer peripheral portion of the first electrode is joined to one surface of the frame sheet member over the entire periphery. The outer peripheral portion of the second electrode is joined to the other surface of the frame sheet member over the entire periphery.

### CROSS-REFERENCE TO RELATED APPLICATIONS

This application is based upon and claims the benefit of priority from Chinese Patent Application No. 202310286602.7 filed on Mar. 22, 2023, the contents of which are incorporated herein by reference.

### BACKGROUND OF THE INVENTION

### Field of the Invention

The present invention relates to a framed membrane electrode assembly.

### Description of the Related Art

In recent years, research and development have been conducted on fuel cells that contribute to energy efficiency in order to ensure that more people have access to affordable, reliable, sustainable and modern energy.

The fuel cell comprises a membrane electrode assembly (MEA). JP 7034212 B2 discloses a framed membrane electrode assembly. The framed membrane electrode assembly includes a membrane electrode assembly and a frame member having a resin sheet. The membrane electrode assembly is formed of an electrolyte membrane, a first electrode, and a second electrode. The frame member is provided over the entire periphery of the membrane electrode assembly.

### SUMMARY OF THE INVENTION

However, when impurities such as iron ions enter the inside of the membrane electrode assembly through the boundary surface between the membrane electrode assembly and the resin sheet, the efficiency of the electrochemical reactions in the membrane electrode assembly tends to decrease. Further, when impurities enter the inside of the membrane electrode assembly, decomposition of the electrolyte membrane tends to be accelerated. Therefore, there has been a demand for a framed membrane electrode assembly with improved structure.

An object of the present invention is to solve the above-described problems.

According to an aspect of the present invention, a framed membrane electrode assembly includes a membrane electrode assembly including an electrolyte membrane, a first electrode, and a second electrode, and a resin frame sheet member surrounding an entire periphery of the membrane electrode assembly, wherein the first electrode and the second electrode extend outwardly of an entire outer peripheral end of the electrolyte membrane, an outer peripheral portion of the first electrode is joined to one surface of the frame sheet member along an entire periphery of the first electrode, and an outer peripheral portion of the second electrode is joined to another surface of the frame sheet member along an entire periphery of the second electrode.

According to the aspect of the present invention, it is possible to suppress incorporation of impurities. As a result, it is possible to suppress a decrease in the efficiency of the electrochemical reactions in the membrane electrode assembly. In addition, deterioration of the electrolyte membrane can be suppressed.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view of a main part of a power generation cell according to an embodiment;

FIG. 2 is a cross-sectional view taken along line II-II of FIG. 1;

FIG. 3 is a graph showing a relationship between a width of the first joining portion and ion penetration; and

FIG. 4 is a cross-sectional view taken along line II-II of FIG. 1 according to a modification.

### DETAILED DESCRIPTION OF THE INVENTION

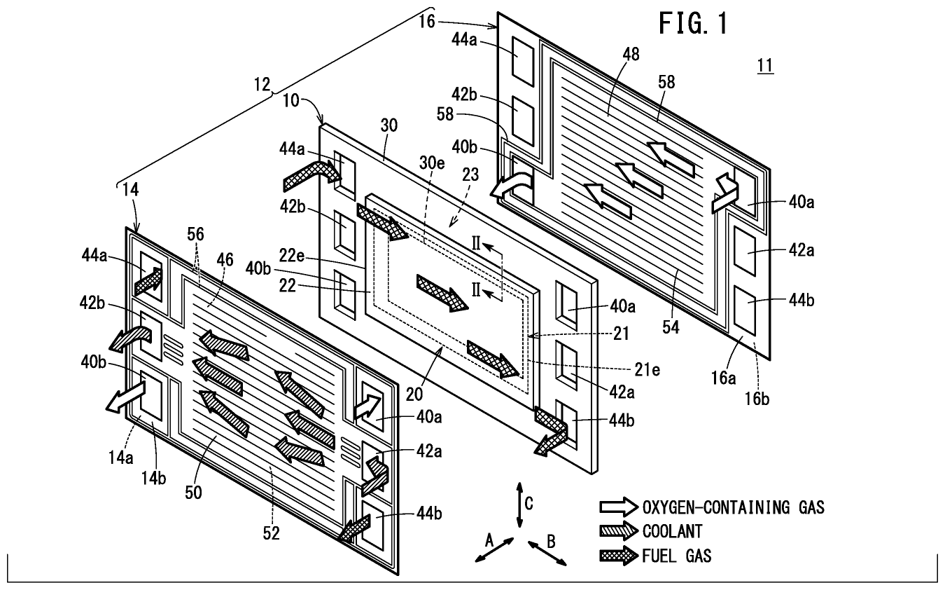

FIG. 1 is an exploded perspective view of a main part of a power generation cell according to an embodiment. The power generation cell 12 is a fuel cell such as a polymer electrolyte fuel cell. A plurality of power generation cells 12 are stacked to form a fuel cell stack 11. The fuel cell stack 11, for example, is mounted in a moving object such as an automobile (not shown).

The power generation cell 12 includes a framed membrane electrode assembly 10, a first separator 14, and a second separator 16. The framed membrane electrode assembly 10 is hereinafter referred to as a framed MEA 10. The framed MEA 10 is sandwiched between the first separator 14 and second separator 16.

The first separator 14 is formed of, for example, a metal plate or a carbon member. The metal plate is, for example, a plate such as a steel plate, a stainless steel plate, an aluminum plate, a titanium plate, a titanium alloy plate, and a plated steel plate. When the first separator 14 is formed of a metal plate, surfaces of the metal plate may be subjected to an anti-corrosion surface treatment.

The second separator 16 is formed of, for example, a metal plate or a carbon member. The metal plate is, for example, a plate such as a steel plate, a stainless steel plate, an aluminum plate, a titanium plate, a titanium alloy plate, and a plated steel plate. When the second separator 16 is formed of a metal plate, surfaces of the metal plate may be subjected to an anti-corrosion surface treatment.

The framed MEA 10, the first separator 14 and the second separator 16 have substantially the same outer shape. FIG. 1 shows an example in which the framed MEA 10, the first separator 14 and the second separator 16 have a rectangular outer shape.

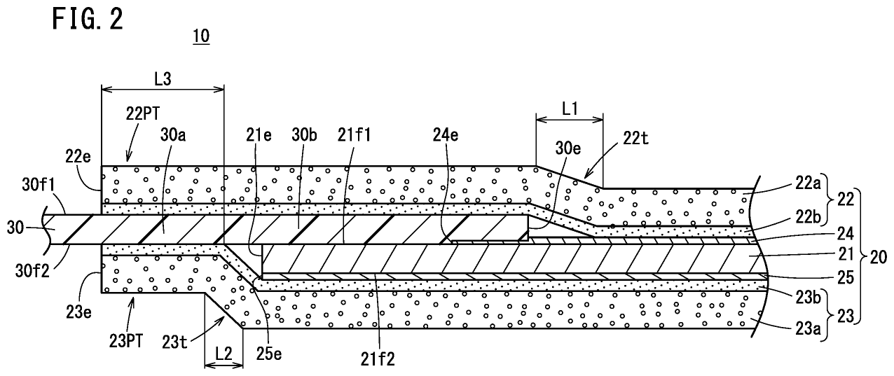

The framed MEA 10 includes a membrane electrode assembly 20 and a frame sheet member 30. The membrane electrode assembly 20 is referred to as an MEA 20. FIG. 2 is a cross-sectional view taken along line II-II of FIG. 1.

The MEA 20 includes an electrolyte membrane 21, a first electrode 22, and a second electrode 23. The MEA 20 includes a first catalyst layer 24 and a second catalyst layer 25 in addition to the electrolyte membrane 21, the first electrode 22, and the second electrode 23.

One of the first electrode 22 and the second electrode 23 is an anode. The other of the first electrode 22 and the second electrode 23 is a cathode. In the present embodiment, the first electrode 22 is the anode. Therefore, the first electrode 22 is hereinafter referred to as the anode 22. In the present embodiment, the second electrode 23 is the cathode. Therefore, the second electrode 23 is hereinafter referred to as the cathode 23.

The electrolyte membrane 21, for example, is a polymer electrolyte membrane (cation exchange membrane). Such a polymer electrolyte membrane, for example, is a thin membrane of perfluorosulfonic acid containing water. The electrolyte membrane 21 is sandwiched and gripped between the anode 22 and the cathode 23. A fluorine based electrolyte may be used as the electrolyte membrane 21. Alternatively, an HC (hydrocarbon) based electrolyte may be used as the electrolyte membrane 21.

The electrolyte membrane 21 has a smaller planar dimension (external dimension) than the anode 22 and the cathode 23. The outer peripheral end 21e of the electrolyte membrane 21 is positioned inwardly of the outer peripheral end 22e of the anode 22 and the outer peripheral end 23e of the cathode 23 over the entire periphery. The entire outer peripheral end 21e of the electrolyte membrane 21 is sandwiched between the cathode 23 and the frame sheet member 30.

The anode 22 has a first gas diffusion layer 22a and a first auxiliary diffusion layer 22b. The cathode 23 has a second gas diffusion layer 23a and a second auxiliary gas diffusion layer 23b.

Each of the first gas diffusion layer 22a and the second gas diffusion layer 23a is formed of, for example, carbon paper, carbon cloth, or the like. Each of the first auxiliary diffusion layer 22b and the second auxiliary diffusion layer 23b is formed of, for example, a composite material of carbon particles and a water-repellent polymer. The first auxiliary diffusion layer 22b and the second auxiliary diffusion layer 23b may not be provided.

The anode 22 and the cathode 23 have a larger planar dimension (outer dimension) than that of the electrolyte membrane 21. Each of the anode 22 and the cathode 23 extends outwardly of the entire outer peripheral end 21e of the electrolyte membrane 21.

An outer peripheral portion 22PT of the anode 22 is joined to one surface 30f1 of the frame sheet member 30. An end portion of the frame sheet member 30 is sandwiched between the anode 22 and the electrolyte membrane 21. Therefore, the anode 22 includes a first inclined portion 22t along the entire periphery of the anode 22. The first inclined portion 22t forms a step in the anode 22. The first inclined portion 22t is positioned inwardly of the outer peripheral end 21e of the electrolyte membrane 21. The first inclined portion 22t is inclined so as to approach the cathode 23, from the outer side toward the inner side. In other words, the first inclined portion 22t approaches the cathode 23 as it becomes away from the inner peripheral end 30e of the frame sheet member 30.

An outer peripheral portion 23PT of the cathode 23 is joined to the other surface 30f2 of the frame sheet member 30. An end portion of the electrolyte membrane 21 is sandwiched between the cathode 23 and the end portion of the frame sheet member 30. Therefore, the cathode 23 includes a second inclined portion 23t along the entire periphery of the cathode 23. The second inclined portion 23t forms a step in the cathode 23. The second inclined portion 23t is positioned outwardly of the inner peripheral end 30e of the frame sheet member 30. The second inclined portion 23t is positioned outwardly of the first inclined portion 22t. The second inclined portion 23t is inclined so as to separate from the anode 22, from the outer side toward the inner side. In other words, the second inclined portion 23t is inclined so as to separate from the anode 22 as it approaches the outer peripheral end 21e of the electrolyte membrane 21.

A width L2 of the second inclined portion 23t in the direction from the outer side toward the inner side of the frame sheet member 30 may be smaller than a width L1 of the first inclined portion 22t in the direction from the outer side toward the inner side of the frame sheet member 30. This applies to any position over the entire periphery. In this case, the inclination of the second inclined portion 23t is steeper than the inclination of the first inclined portion 22t. The total thickness of the electrolyte membrane 21, the first catalyst layer 24, and the second catalyst layer 25 may be equal to or larger than the thickness of the frame sheet member 30.

Each of the first catalyst layer 24 and the second catalyst layer 25 contains platinum. The first catalyst layer 24 and the second catalyst layer 25 are formed of, for example, porous carbon particles with platinum alloy supported on surfaces thereof. Each of the first catalyst layer 24 and the second catalyst layer 25 has a planar dimension (outer dimension) smaller than those of the anode 22 and the cathode 23.

The first catalyst layer 24 is joined to the surface 21f1 of the electrolyte membrane 21 via, for example, an ion conductive polymer binder. The second catalyst layer 25 is joined to the surface 21f2 of the electrolyte membrane 21 opposite to the surface 21f1 via, for example, an ion conductive polymer binder.

The first catalyst layer 24 has a planar dimension (outer dimension) smaller than that of the second catalyst layer 25. The outer peripheral end 24e of the first catalyst layer 24 is positioned inwardly of the outer peripheral end 25e of the second catalyst layer 25 over the entire periphery. The outer peripheral end 24e of the first catalyst layer 24 is positioned between the electrolyte membrane 21 and the frame sheet member 30. The second catalyst layer 25 is stacked on the entire surface of the electrolyte membrane 21. That is, the outer peripheral end 25e of the second catalyst layer 25 extends to the same extent as the outer peripheral end 21e of the electrolyte membrane 21. The outer peripheral end 24e of the first catalyst layer 24 is positioned inwardly of the outer peripheral end 25e of the second catalyst layer 25.

The frame sheet member 30 surrounds the entire periphery of the MEA 20. The frame sheet member 30 is a sheet member made of resin. The frame sheet member 30 is formed in a flat shape as one sheet.

Examples of the material of the frame sheet member 30 include polyphenylene sulfide (PPS), polyphthalamide (PPA), polyethylene naphthalate (PEN), polyether sulfone (PES), liquid crystal polymer (LCP), polyvinylidene fluoride (PVDF), silicone resin, fluorine resin, modified polyphenylene ether resin (m-PPE), polyethylene terephthalate (PET), polybutylene terephthalate (PBT), and modified polyolefin.

The thickness of the frame sheet member 30 may be smaller than the thickness of the anode 22 or may be smaller than the thickness of the cathode 23. The inner peripheral portion of the frame sheet member 30 is disposed between the anode 22 and the cathode 23. The inner peripheral portion of the frame sheet member 30 has a first joining portion 30a and a second joining portion 30b.

The first joining portion 30a is a portion joined to each of the anode 22 and the cathode 23. The first joining portion 30a surrounds the second joining portion 30b. The first joining portion 30a does not overlap the electrolyte membrane 21. The one surface 30f1 at the first joining portion 30a is joined to the outer peripheral portion 22PT of the anode 22 over the entire periphery. The first joining portion 30a and the outer peripheral portion 22PT of the anode 22 are joined to each other by adhesion or fusion. The other surface 30f2 at the first joining portion 30a is joined to the outer peripheral portion 23PT of the cathode 23 over the entire periphery. The first joining portion 30a and the outer peripheral portion 23PT of the cathode 23 are joined to each other by adhesion or fusion.

The second joining portion 30b is a portion joined to each of the anode 22 and the electrolyte membrane 21, and is separated from the first joining portion 30a. The second joining portion 30b is surrounded by the first joining portion 30a. The second joining portion 30b overlaps the electrolyte membrane 21. The one surface 30f1 at the second joining portion 30b is joined to the outer peripheral portion 22PT of the anode 22 over the entire periphery. The second joining portion 30b and the outer peripheral portion 22PT of the anode 22 are joined to each other by adhesion or fusion.

The outer part of the other surface 30f2 at the second joining portion 30b is joined to the electrolyte membrane 21 over the entire periphery. The inner part of the other surface 30f2 at the second joining portion 30b is joined to the first catalyst layer 24 over the entire periphery. The second joining portion 30b is joined to the electrolyte membrane 21 and the first catalyst layer 24 by adhesion or fusion.

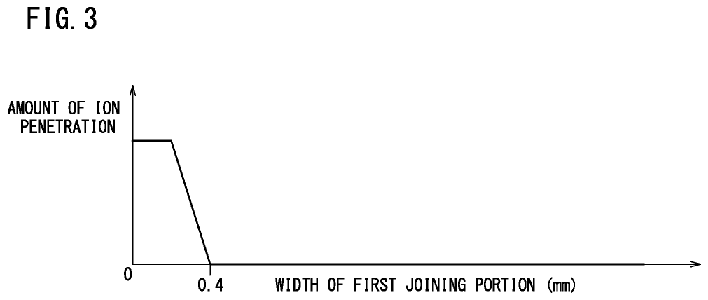

FIG. 3 is a graph showing a relationship between a width L3 (see FIG. 2) of the first joining portion 30a and ion penetration (permeation). The width L3 of the first joining portion 30a is the width in the direction from the outer side toward the inner side of the frame sheet member 30 (the planar direction). An amount of ion penetration is the amount of ions that reach the inside of the framed MEA 10 (the outer peripheral end 21e of the electrolyte membrane 21) from the outside. Ions reach the inside of the framed MEA 10 via at least one of the boundary surface between the first joining portion 30a and the anode 22 and the boundary surface between the first joining portion 30a and the cathode 23.

It was experimentally found that the amount of ion penetration is substantially zero when the width L3 of the first joining portion 30a is 0.4 mm or more. The same results were obtained in both of the case where the first joining portion 30a was joined to the anode 22 and the cathode 23 by adhesion and the case where the first joining portion 30a was joined to the anode 22 and the cathode 23 by fusion.

In this way, in the framed MEA 10, the anode 22 and the cathode 23 form a sealing by sandwiching the frame sheet member 30. The end of the frame sheet member 30 and the end of the electrolyte membrane 21 are arranged inwardly of and enclosed by the sealing of the framed MEA 10. Therefore, the number of the frame sheet members 30 included in the sealing can be one so that the framed MEA 10 can be thinned.

Next, the flow path configuration of the power generation cell 12 will be described. As shown in FIG. 1, at one edge portion of the power generating cell 12 in the arrow B direction (horizontal direction), an oxygen-containing gas supply passage 40a, a coolant supply passage 42a, and a fuel gas discharge passage 44b extend in the arrow A direction as a stacking direction. An oxygen-containing gas is supplied through the oxygen-containing gas supply passage 40a. A coolant is supplied through the coolant supply passage 42a. A fuel gas, for example, a hydrogen-containing gas, is discharged through the fuel gas discharge passage 44b. The oxygen-containing gas supply passage 40a, the coolant supply passage 42a, and the fuel gas discharge passage 44b are arranged in the arrow C direction (vertical direction).

At the other edge portion of the power generating cell 12 in the arrow B direction, a fuel gas supply passage 44a for supplying the fuel gas, a coolant discharge passage 42b for discharging the coolant, and an oxygen-containing gas discharge passage 40b for discharging the oxygen-containing gas are provided. The fuel gas supply passage 44a, the coolant discharge passage 42b, and the oxygen-containing gas discharge passage 40b are arranged in the direction indicated by the arrow C.

The first separator 14 has a fuel gas flow field 46 on its surface 14a facing the framed MEA 10. The fuel gas flow field 46 is connected to the fuel gas supply passage 44a and the fuel gas discharge passage 44b. Specifically, the fuel gas flow field 46 is formed between the first separator 14 and the framed MEA 10. The fuel gas flow field 46 includes a plurality of straight flow grooves (or wavy flow grooves) extending in the direction indicated by the arrow B.

The second separator 16 has an oxygen-containing gas flow field 48 on its surface 16a facing the framed MEA 10. The oxygen-containing gas flow field 48 is connected to the oxygen-containing gas supply passage 40a and the oxygen-containing gas discharge passage 40b. Specifically, the oxygen-containing gas flow field 48 is formed between the second separator 16 and the framed MEA 10. The oxygen-containing gas flow field 48 includes a plurality of straight flow grooves (or wavy flow grooves) extending in the arrow B direction.

Between the surface 14b of the first separator 14 and the surface 16b of the second separator 16 adjacent to each other in a state where the fuel cells are stacked together, a coolant flow field 50 is formed to extend in the arrow B direction to connect the coolant supply passage 42a and the coolant discharge passage 42b.

A plurality of ridges 52 forming the fuel gas flow field 46 are formed on the surface 14a of the first separator 14 (the surface facing the framed MEA 10). The ridges 52 protrude toward the anode 22 and contacts the anode 22. A plurality of ridges 54 forming the oxygen-containing gas flow field 48 are formed on the surface 16a of the second separator 16 (the surface facing the framed MEA 10). The ridges 54 protrude toward the cathode 23 and contacts the cathode 23. The MEA 20 is held between the ridges 52, 54.

The surface 14a of the first separator 14 is provided with at least one bead seal 56 that surrounds the outer peripheral portion of the first separator 14 in order to prevent leakage of the fuel gas to the outside. The bead seal 56 is formed by press-forming so as to protrude toward the frame sheet member 30. The inner bead seal 56 is formed around the fuel gas flow field 46, the fuel gas supply passage 44a, and the fuel gas discharge passage 44b in a manner that the fuel gas flow field 46 is connected to the fuel gas supply passage 44a and the fuel gas discharge passage 44b.

To the projecting end surface of the bead seal 56, a first seal member is firmly attached by printing or coating, etc. The bead seal 56 is in contact with the frame sheet member 30 in an air-tight and liquid-tight manner via the first seal member. The first seal member may be firmly attached to the frame sheet member 30.

The first separator 14 may be provided with a convex seal made of an elastic body protruding toward the frame sheet member 30, instead of the bead seal 56.

The surface 16a of the second separator 16 is provided with at least one bead seal 58 that surrounds the outer peripheral portion of the second separator 16 in order to prevent leakage of the oxygen-containing gas to the outside. The bead seal 58 is formed by press-forming so as to protrude toward the frame sheet member 30. The inner bead seal 58 is formed around the oxygen-containing gas flow field 48, the oxygen-containing gas supply passage 40a, and the oxygen-containing gas discharge passage 40b in a manner that the oxygen-containing gas flow field 48 is connected to the oxygen-containing gas supply passage 40a and the oxygen-containing gas discharge passage 40b.

To the projecting end surface of the bead seal 58, a second seal member is firmly attached by printing or coating, etc. The bead seal 58 is in contact with the frame sheet member 30 in an air-tight and liquid-tight manner via the second seal member. The second seal member may be firmly attached to the frame sheet member 30.

The second separator 16 may be provided with a convex seal made of an elastic body protruding toward the frame sheet member 30, instead of the bead seal 58.

The first seal member or the second seal member is made of, for example, polyester fiber, silicone, EPDM (ethylene propylene diene monomer), FKM (fluoroelastomer), or the like. The first seal member or the second seal member is non-essential, and need not necessarily be provided. In the absence of the first seal member, the bead seal 56 would directly abut the frame seat member 30. In the absence of the second seal member, the bead seal 58 would directly abut the frame seat member 30.

The bead seal 56 and the bead seal 58 sandwich the frame sheet member 30. The outer peripheral portion of the frame sheet member 30 is sandwiched between the bead seal 56 of the first separator 14 and the bead seal 58 of the second separator 16. When the first separator 14 and the second separator 16 are provided with the convex seals protruding toward the frame sheet member 30, the outer peripheral portion of the frame sheet member 30 is sandwiched between the convex seal of the first separator 14 and the convex seal of the second separator 16.

Operations of the fuel cell stack 11 including the power generation cells 12, which is constructed in the foregoing manner, will be described below with reference to FIG. 1.

The oxygen-containing gas is supplied to the oxygen-containing gas supply passage 40a. The fuel gas such as a hydrogen-containing gas is supplied to the fuel gas supply passage 44a. Further, the coolant such as pure water, ethylene glycol, or oil is supplied to the coolant supply passage 42a.

The oxygen-containing gas supplied from the oxygen-containing gas supply passage 40a into the oxygen-containing gas flow field 48 of the second separator 16 flows in the arrow B direction, and thus, the oxygen-containing gas is supplied to the cathode 23 of the MEA 20. In the meanwhile, the fuel gas supplied from the fuel gas supply passage 44a into the fuel gas flow field 46 of the first separator 14 flows along the fuel gas flow field 46 in the arrow B direction, and thus, the fuel gas is supplied to the anode 22 of the MEA 20.

In the MEA 20, the oxygen-containing gas supplied to the cathode 23 and the fuel gas supplied to the anode 22 are consumed in the second catalyst layer 25 and the first catalyst layer 24 by electrochemical reactions, thereby generating electricity.

Subsequently, the remainder of the oxygen-containing gas supplied to and consumed at the cathode 23 is discharged in the direction of arrow A along the oxygen-containing gas discharge passage 40b. Similarly, the remainder of the fuel gas supplied to and consumed at the anode 22 is discharged in the direction of arrow A along the fuel gas discharge passage 44b.

Further, the coolant supplied to the coolant supply passage 42a is introduced into the coolant flow field 50 between the first separator 14 and the second separator 16, and then flows in the arrow B direction. After cooling the MEA 20, the coolant is discharged from the coolant discharge passage 42b.

The above-described embodiment may be modified in the following manner.

### Modified Embodiment 1

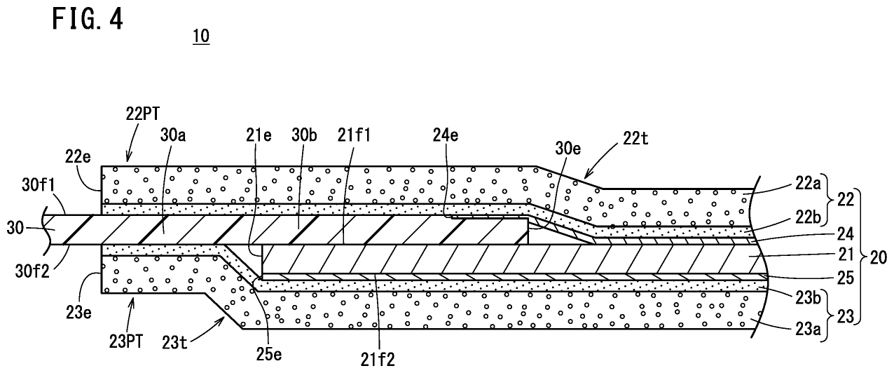

FIG. 4 is a cross-sectional view taken along line II-II of FIG. 1 according to a Modified Embodiment 1. In Modified Embodiment 1, the first catalyst layer 24 is joined to the anode 22 (first electrode 22). For example, the first catalyst layer 24 is joined to the anode 22 via an ion conductive polymer binder. In the case of Modified Embodiment 1, the outer peripheral end 24e of the first catalyst layer 24 is positioned between the frame sheet member 30 and the first electrode 22.

In this way, the first catalyst layer 24 may be joined to the anode 22 (first electrode 22). The second catalyst layer 25 may be joined to the electrolyte membrane 21 or the cathode 23 (second electrode 23).

### Modified Embodiment 2

Although not shown in the drawings, the outer peripheral end 24e of the first catalyst layer 24 may be in contact with the inner peripheral end 30e of the frame sheet member 30 without being sandwiched between the electrolyte membrane 21 and the frame sheet member 30 or between the frame sheet member 30 and the first electrode 22. In this case, the first catalyst layer 24 may be joined to the electrolyte membrane 21 or the first electrode 22.

A disclosure will be given concerning the invention that is capable of being grasped from the description provided above.

### APPENDIX 1

The present invention is to provide the framed membrane electrode assembly (10) including the membrane electrode assembly (20) including the electrolyte membrane (21), the first electrode (22) and the second electrode (23), and the resin frame sheet member (30) surrounding the entire periphery of the membrane electrode assembly. The first electrode and the second electrode extend outwardly of the entire outer peripheral end (21e) of the electrolyte membrane, the outer peripheral portion (22PT) of the first electrode is joined to the one surface (30fl) of the frame sheet member along an entire periphery of the first electrode, and the outer peripheral portion (23PT) of the second electrode is joined to the other surface (30f2) of the frame sheet member along an entire periphery of the first electrode.

With this arrangement, it is possible to suppress incorporation of impurities. As a result, it is possible to suppress a decrease in the efficiency of the electrochemical reactions in the membrane electrode assembly. In addition, deterioration of the electrolyte membrane can be suppressed.

### APPENDIX 2

In the framed membrane electrode assembly according to Appendix 1, the frame sheet member includes the first joining portion (30a), to which the first electrode and the second electrode are joined, and the first joining portion may have a width (L3) of 0.4 mm or more in the direction from the outer side to the inner side of the frame sheet member. This can substantially eliminate the mixing of impurities.

### APPENDIX 3

In the framed membrane electrode assembly according to Appendix 1, the first electrode may include the first inclined portion (22t) along the entire periphery of the first electrode, the second electrode may include the second inclined portion (23t) along the entire periphery of the second electrode, the first inclined portion may approach the second electrode from the outer side toward the inner side, and the second inclined portion may be positioned outwardly of the first inclined portion and may be inclined so as to separate from the first electrode from the outer side toward the inner side. In accordance with this feature, the membrane electrode assembly can be made as thin as possible.

### APPENDIX 4

In the framed membrane electrode assembly according to Appendix 3, the width (L2) of the second inclined portion in the direction from the outer side to the inner side of the frame sheet member may be smaller than the width (L1) of the first inclined portion in the direction from the outer side to the inner side of the frame sheet member over the entire periphery. In accordance with this feature, the membrane electrode assembly can be made as thin as possible.

### APPENDIX 5

In the framed membrane electrode assembly according to Appendix 1, the membrane electrode assembly includes the first catalyst layer (24) provided between the electrolyte membrane and the first electrode, and the second catalyst layer (25) provided between the electrolyte membrane and the second electrode, and the outer peripheral end (24e) of the first catalyst layer may be positioned inwardly of the outer peripheral end (25e) of the second catalyst layer over the entire periphery. In this way, the amount of the catalyst to be used can be minimized.

### APPENDIX 6

In the framed membrane electrode assembly according to Appendix 5, the outer peripheral end of the first catalyst layer may be positioned between the electrolyte membrane and the frame sheet member or between the frame sheet member and the first electrode. This can suppress exposure of the electrolyte membrane inside the membrane electrode assembly. As a result, it is possible to suppress a decrease in the efficiency of the electrochemical reactions.

### APPENDIX 7

In the framed membrane electrode assembly according to Appendix 1, each of the first electrode and the second electrode may be joined to the frame sheet member by adhesion or fusion over the entire periphery. This can suppress incorporation of impurities into the membrane electrode assembly.

### APPENDIX 8

In the framed membrane electrode assembly according to Appendix 1, the outer peripheral end of the electrolyte membrane may be positioned between the second electrode and the frame sheet member over the entire periphery. This can suppress exposure of the electrolyte membrane inside the membrane electrode assembly. As a result, it is possible to suppress a decrease in the efficiency of the electrochemical reactions.

The present invention is not limited to the above disclosure, and various modifications can be adopted therein without departing from the essence and gist of the present invention.

1. A framed membrane electrode assembly comprising: a membrane electrode assembly including an electrolyte membrane, a first electrode and a second electrode; and
a resin frame sheet member surrounding an entire periphery of the membrane electrode assembly, wherein
the first electrode and the second electrode extend outwardly of an entire outer peripheral end of the electrolyte membrane,
an outer peripheral portion of the first electrode is joined to one surface of the frame sheet member along an entire periphery of the first electrode, and
an outer peripheral portion of the second electrode is joined to another surface of the frame sheet member along an entire periphery of the first electrode.

2. The framed membrane electrode assembly according to claim 1, wherein
the frame sheet member includes a first joining portion, to which the first electrode and the second electrode are joined, and the first joining portion has a width of 0.4 mm or more in a direction from an outer side to an inner side of the frame sheet member.

3. The framed membrane electrode assembly according to claim 1, wherein
the first electrode includes a first inclined portion along an entire periphery of the first electrode,
the second electrode includes a second inclined portion along an entire periphery of the second electrode,
the first inclined portion is inclined to approach the second electrode from an outer side toward an inner side, and
the second inclined portion is positioned outwardly of the first inclined portion and inclined to separate from the first electrode from the outer side toward the inner side.

4. The framed membrane electrode assembly according to claim 3, wherein
a width of the second inclined portion in a direction from an outer side to an inner side of the frame sheet member is smaller than a width of the first inclined portion in the direction from the outer side to the inner side of the frame sheet member over the entire periphery.

5. The framed membrane electrode assembly according to claim 1, wherein
the membrane electrode assembly includes a first catalyst layer provided between the electrolyte membrane and the first electrode, and a second catalyst layer provided between the electrolyte membrane and the second electrode, and
an outer peripheral end of the first catalyst layer is positioned inwardly of an outer peripheral end of the second catalyst layer over the entire periphery.

6. The framed membrane electrode assembly according to claim 5, wherein
the outer peripheral end of the first catalyst layer is positioned between the electrolyte membrane and the frame sheet member or between the frame sheet member and the first electrode.

7. The framed membrane electrode assembly according to claim 1, wherein
each of the first electrode and the second electrode is joined to the frame sheet member by adhesion or fusion over the entire periphery.

8. The framed membrane electrode assembly according to claim 1, wherein
the outer peripheral end of the electrolyte membrane is positioned between the second electrode and the frame sheet member over the entire periphery.
